(19) United States
(12) Patent Application Publication
(10) Pub. No.: US 2016/0275633 A1
(43) Pub. Date: Sep. 22, 2016

(54) UTILITY MONITORING AND DATABASE CORRELATION SYSTEM, INCLUDING USER INTERFACE GENERATION FOR UTILITY ASSESSMENT

(71) Applicant: BKI SOFTWARE SOLUTIONS, Oakland, CA (US)

(72) Inventors: Brian Keith Gitt, San Francisco, CA (US); Rebecca Catherine Brown, Oakland, CA (US)

(21) Appl. No.: 15/074,734

(22) Filed: Mar. 18, 2016

Related U.S. Application Data
(60) Provisional application No. 62/136,372, filed on Mar. 20, 2015.

(51) Int. Cl. G06Q 50/16; G06Q 30/02; G06Q 50/06; G06F 17/30

(52) U.S. Cl. CPC G06Q 50/16; G06F 17/3053; G06Q 30/0283; G06Q 50/06

(57) ABSTRACT

Methods, systems, and apparatus, including computer programs encoded on computer storage media, for utility assessments. One of the methods includes receiving a request associated with a particular property for utility estimates of the particular property. One or more databases are accessed and information describing the particular property is obtained, the information including characteristics of the property that affect utility usage associated with the particular property. Utility estimates for the property are determined using characteristics of the property, and the utility estimates are combined to generate a utility score representing an overall utility efficiency with respect to other properties. User interface data associated with the determined utility estimates and utility score is provided for presentation, with the user interface data including selectable options for the user to specify refinements to characteristics of the property, and where selection of refinement information triggers the system to update the utility estimates and utility score.

### CROSS-REFERENCE TO RELATED APPLICATIONS

Any and all applications for which a foreign or domestic priority claim is identified in the Application Data Sheet as filed with the present application are hereby incorporated by reference in their entirety under 37 CFR 1.57.

### BACKGROUND

When purchasing a building, a buyer will generally examine multiple costs associated with buying and owning the building, such as a home. For instance, the buyer can calculate an expected mortgage based off the purchase price of the building and mortgage rates, a down payment the buyer has access to, and whether private mortgage insurance will be necessary. However, other factors may also affect the actual costs of owning the house. Accordingly there is a need to aid a buyer with determining actual costs of building ownership to help the buyer conform to the buyer's financial situation.

### SUMMARY

Particular embodiments of the subject matter described in this specification can be implemented so as to realize one or more of the following advantages. A system can monitor utility usage of properties in one or more areas, and utility rates for the areas, and using information describing a property selected by a user, can determine utility estimates for the selected property. The information describing the property can be obtained from one or more real estate information sites that monitor properties, such as REDFIN™ or ZILLOW™. Beneficially, the system can maintain property profile information for the property, with the profile information including characteristics of the property, upgrades made to the property, and so on, which would otherwise unavailable on public real estate information sites. Prior owners of the property, appraisers, building inspectors, can update the profile information, enabling the system to utilize detailed information to generate refinements to the utility estimates. For instance, the profile can indicate that a property owner installed efficient windows, water heater, air conditioner, or appliances, and the system can refine the determined utility estimates. Through monitoring properties according to profile information, and by accessing sales information for properties, the system can determine correlations between sales price and utility estimates. For instance, the system can determine that a particular property with an upgraded heating and cool system, water heater, along with efficient appliances, will sell for a particular amount, or percentage, greater than a similar property without the upgrades.

In another instance, the profile can store indications of actual systems, products, or appliances included in the property, for instance a real estate agent or homeowner can walk through the property capturing imagery of nameplates, barcodes, of each appliance, or imagery of features of the property (e.g., insulation type, window type, lawn type), and the system can utilize computer vision techniques to identify the application (e.g., particular SKU), or features. Using the actual appliance information, and feature information, the system can refine the determined utility estimates (e.g., lower the utility estimates). The system can generate user interface data (e.g., web pages) for presentation on user devices that illustrate historical information of a selected property, including upgrades made to the property, determined utility estimates for one or more times, and so on.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a block diagram of an example utility assessment system.

FIG. 2 is a flowchart of an example process for utility cost assessment.

FIG. 3 is a flowchart of an example process for user refinement of a utility cost assessment.

FIG. 4 is a flowchart of an example process for determining utility cost estimates.

FIG. 5A is an illustration of an example user interface for utility cost assessment displaying an example utility assessment score.

FIG. 5B is an illustration of an example expanded user interface for utility cost assessment.

FIG. 5C is an illustration of an example user interface for utility cost assessment displaying information about utility assessment scores.

FIG. 5D is an illustration of an example user interface for utility cost assessment displaying refinement information.

FIG. 5E is an illustration of an example user interface for utility cost assessment displaying utility assessment score comparisons.

FIG. 5F is an illustration of an example user interface for entering refinement information.

FIG. 5G is an illustration of an example user interface for providing utility score comparisons.

FIG. 5H is an illustration of an example user interface for providing information describing a utility score.

FIG. 6 is an example flowchart for maintaining and utilizing property profile information.

FIG. 7 is an example user interface illustrating a visual output associated with utility assessments for a geographic area.

Like reference numbers and designations in the various drawings indicate like elements.

### DETAILED DESCRIPTION

This specification describes techniques to determine utility cost assessments for property, e.g., homes, businesses, and so on, and determine utility assessment scores for the properties (e.g., an overall utility score determined from utility cost estimates, which can be used to compare utility efficiencies of properties). In this specification, utility cost assessments include cost estimates for particular utilities in one or more time periods, e.g., an estimate of an average yearly cost, an estimate of an average cost during particular months and/season. In particular, a system can receive a selection of a property, e.g., a house, condo, townhome, rental, or commercial property, and obtain information describing the property, such as characteristics including year the property was built, square footage of the property, number of bedrooms, number of bathrooms, square footage of land, or other information that can affect utility usage. The system can then obtain information describing the climate of an area that includes the property (e.g., climate zone boundaries established by the International Energy Conservation Code, and the mean local temperature, rainfall, and so on, information from the National Oceanic and Atmosphere Administration), and determine estimated costs associated with various utilities, e.g., electricity costs, natural gas costs, water costs, and sewer costs. The system can then determine an overall utility assessment score for the property, which can be useful for comparing properties in a same area, e.g., metropolitan region, city, and so on.

Additionally, the utility assessment score can be refined using actual data associated with the property, for instance data entered by a user. As an example, the user can specify a number of occupants in the property, including whether the occupants generally stay in the property during daytime, a measure of central tendency of a thermostat setting (e.g., a mean thermostat setting the occupants prefer), and so on. Refinements can also include specific property systems included in the property, such as a specific water heater, a low-flow toilet, a specific washer/dryer, specific window, specific insulation, and so on. The system can modify the utility assessment score with this specified refinement information, allowing the system to determine more empirically grounded and accurate utility assessments. In this specification, a property system is any physical object, appliance, system, structure, material, vegetation included in, or otherwise associated with, the property that can affect overall utility consumption, or efficiency of utility usage, of, or by, the property. For instance, a property system can include a water heater, toilet, rain collection system, lawn type (e.g., type of grass), vegetation used (e.g., native plants), insulation, window type (e.g., double paned windows), and so on.

The system can maintain, or receive (e.g., from an outside system that maintains property profiles), property profile information for one or more properties, with the property profile monitoring information that can affect or inform utility cost estimates or utility assessment scores. As an example, a property profile can include information describing utility cost estimates, and a utility assessment score, for an associated property over a period of time (e.g., the system can periodically determined utility cost estimates). The property profile can include information describing property improvement projects that have been implemented, and using the described information, the system can adjust utility cost estimates and utility assessment scores (e.g., a water utility cost estimate can be reduced if the property includes toilets characterized as ‘low-flow,’ for instance with an amount of water per flush of about 1.6 gallons). When purchasing a property, a user can access one or more user interfaces generated by the system (e.g., render web pages generated by the system), and view property profile information for the property. In this way, the user can obtain accurate utility information specific to the property, providing a window into a large cost of home ownership. The user can therefore investigate multiple properties, and by viewing associated property profiles, can quickly determine which properties (e.g., properties with similar characteristics) will provide lower utility costs and greater efficiencies of ownership.

A property owner can update a property profile associated with his/her property, and can specify property improvement projects that have been made. To ensure that the property owner is providing accurate information, the system can further receive verification information from a private, or governmental, inspector. For instance, the system can authenticate particular users as being private, or governmental, inspectors, appraisers, realtors, and can specify which property improvement projects have been verified. Similarly, the system can provide a greater weight (e.g., measure of confidence) to property improvement projects that have been verified. As an example of a property improvement project to install low-flow toilets, the system can determine an estimate reduction in water utility cost estimates, and if the project is verified, can modify the water utility cost estimate by the full amount of the determined estimate in water reduction.

Since the determined utility assessment scores can indicate, for a particular property, an efficiency of the particular property with respect to utility usage (e.g., in comparison to other properties with similar characteristics), a utility assessment score can be correlated with actual purchase price of the particular property. That is, the system can determine (e.g., using one or more machine learning models), correlations between utility assessment scores and purchase prices of homes. The system can monitor actual selling prices of homes, and can use the selling prices and associated utility assessment scores of the homes, to determine an expected increase, or decrease, in selling price of a home given a particular utility assessment score. In this way, property owners can be incentivized to perform property improvement projects to obtain a higher utility assessment score.

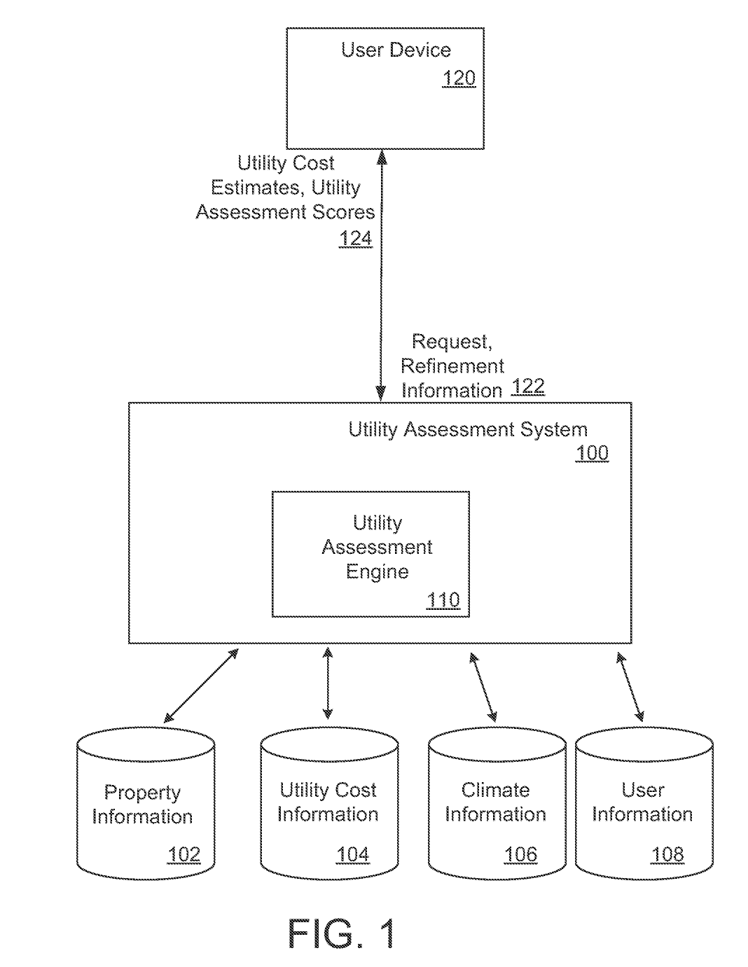

FIG. 1 illustrates a block diagram of an example utility assessment system 100. The utility assessment system 100 can be a system of one or more computers, or software executing on a system of one or more computers. The utility assessment system 100 receives requests, e.g., request 122, identifying properties and provides utility cost assessments, e.g., cost estimates for utilities and utility assessment scores, for each of the properties in respective responses.

The utility assessment system 100 includes a utility assessment engine 110 that can receive a request 122 from a user device 120, e.g., a laptop, tablet, smart phone, wearable device, identifying a property. For instance, a user of the user device 120 can view a resource, e.g., a webpage, that includes selectable options to view properties in a user selected area. The user can select a particular property, and the utility assessment engine 110 can receive an identification of the property. In some implementations, the utility assessment system 100 is in communication with, or a part of, a system that provides the resource to the user device 120. That is, the utility assessment engine 110 can act as a backend system that provides information, e.g., utility cost assessments, to a front end system configured to provide information to a user.

The utility assessment engine 110 can obtain information describing the property identified in the request 122. To obtain information, the utility assessment engine 110 can access a property information database 102 that the utility assessment system 100 is in communication with, or, in some implementations, maintains. The property information database 102 stores (e.g., temporarily store, for example in a non-transitory manner, or permanently store) years that properties were built, square footage of properties, number of bedrooms in respective properties, number of bathrooms in respective properties, square footage of land area, and so on. In some implementations the utility assessment engine 110 can obtain information from the property information database 102 by utilizing Application Programming Interface (API) calls to an outside system that maintains the database 102.

In some implementations, the property information database 102 can store supplemental information obtained from one or more realtor databases, e.g., Multiple Listing Service (MLS), or government records. The utility assessment engine 110 can parse the realtor databases to identify information describing properties, and store the parsed information in the property information database 102. For instance, the utility assessment engine 110 can obtain descriptive text included by a realtor, e.g., “This home includes top of the line solar panels,” and parse the text to identify particular keywords, e.g., “solar panels.” Additionally, the utility assessment engine 110 can perform pattern matching, e.g., perform comparisons on sequences of tokens, e.g., characters, words, for the presence of constituents of particular patterns, on the realtor databases, and other techniques to obtain supplemental information. In some other implementations, the utility assessment engine 110 can determine the supplemental information, and store the supplemented information in one or more memory devices, e.g., volatile, non-volatile memory, included in, or accessible to, the utility assessment system 100.

The utility assessment engine 110 can determine utility cost assessments for various utilities, e.g., electricity, natural gas, water, and sewer, for the property identified in the request 122. The utility cost assessments include estimated costs, e.g., yearly costs, seasonal costs, specific monthly costs, and so on, for each of the utilities. To determine utility cost assessments, the utility assessment engine 110 can obtain utility rates for an area that includes the property, climate information for the area, typical conditions for homes in that area, and can determine expected usage of each utility. Optionally, the user of the user device 120 can specify a type of fuel that is utilized at the property. For instance, the user can specify that heating oil, or propane, will be utilized instead of natural gas. Optionally, the utility assessment engine 110 can obtain information specific to a geographic region that includes the requested property, and determine a type of fuel utilized in the geographic region. Additionally, in some areas there might be options for a property owner to select specific utility companies. For instance, an area might allow a property owner to select between one or more utility companies that provide electricity, and select between one or more utility companies that provide natural gas. The utility assessment engine 110 can receive information (e.g., from a user) specifying a particular utility company. Furthermore, as will be described the utility assessment engine 110 can provide information to a user specifying an optimal utility company of a multitude of utility companies (e.g., the optimal utility company can offer a utility at a lower overall cost, which can include the inclusion of rebates being offered, and so on).

To obtain utility rates for the area that includes the property, the utility assessment engine 110 can access a utility cost information database 104 that the utility assessment system 100 is in communication with, or in some implementations maintains. The utility cost information database 104 can store utility rates for different areas of a country, e.g., the United States. For instance, the utility cost information database 104 can store utility rates for various utilities for each city and/or county in the country, each metropolitan region, and so on. Additionally, the utility cost information database 104 can store usage tier rates, monthly and/or seasonal utility rates, e.g., the price of a utility such as natural gas can be higher in the winter months. In some implementations the utility assessment engine 110 can identify the utility rates by accessing a web site provided by utility companies and parsing the web site to identify utility rate information.

Similarly, the utility assessment engine 110 can obtain climate information for the area that includes the property identified in the request 122. The climate information can be stored in a climate information database 106 in communication with, or maintained by, the utility assessment system 100. The climate information database 106 can store climate information of various granularities for regions, e.g., climate information for each city, county, metropolitan region, state, or climate information from the International Energy Conservation Code and National Oceanic Atmospheric Administration. The climate information in database 106 can be changed over time based on updated local climate data published from public sources. Optionally, the utility assessment engine 110 can obtain (e.g., from a search engine, using API calls to a company, or governmental entity, associated with weather prediction) upcoming weather information and modify the clime information based on the upcoming weather. For instance, if a particular area usually has particular rainfall, but in the next several months is expected to have larger quantities of rainfall (e.g., due to a predicted El Niño), the system can modify the obtained climate information.

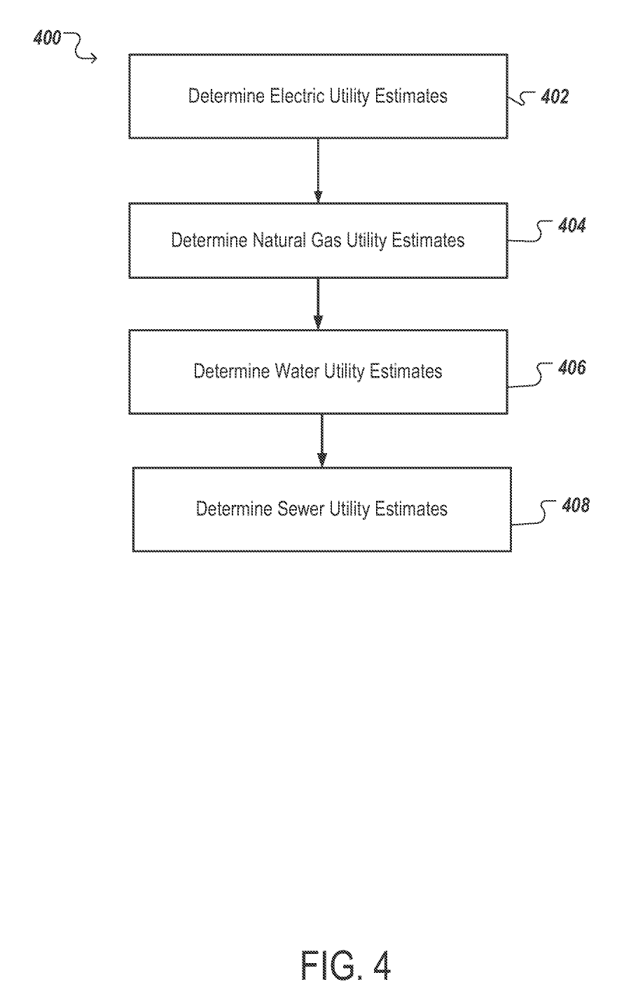

After obtaining utility rates and climate information, the utility assessment engine 110 can determine utility cost estimates 124 for an average year, particular months and/or seasons, e.g., winter, summer, October-March, April-September. For instance, the utility assessment engine 110 can determine expected usage of electricity from the square footage of the property, number of rooms, whether an air conditioner is included in the property. The utility assessment engine 110 can then apply utility rates and climate information, e.g., a number of Cooling Degree Days. Determining utility cost estimates 124 is described below, with respect to FIG. 4.

The utility assessment engine 110 can determine a utility assessment score 124, e.g., an overall score indicating an amount of utility costs associated with the property relative to other properties, e.g., in the same area, country, and so on. The utility assessment score 124 can be normalized with respect to other properties in the same area, e.g., metropolitan region, city, allowing a user an easy way to compare a selected property with other properties. The utility assessment engine 110 can determine the utility assessment score 124 from the utility cost estimates 124 for each of the various utilities. For instance, the utility assessment engine 110 can compute the sum of the utility cost estimates 124 for an average year, and determine a utility assessment score 124 from the sum. Additionally, the utility assessment engine 110 can determine utility assessment scores 124 for each utility, or for particular months and/or seasons.

After determining utility cost assessments 124, e.g., utility cost estimates 124 for various utilities and a utility assessment score, the utility assessment engine 110 can provide the utility cost assessments 124 for presentation on the user device 120. Additionally, the utility assessment engine 110 can provide an average utility assessment score 124 for the area that includes the property, and average utility cost estimates for various utilities in the area. Additionally, the utility assessment engine 110 can present information identifying utility assessment scores, and optionally utility cost assessments 124, for other properties in a same geographic area, neighborhood, and optionally with similar characteristics, as the requested property. In this way, the user can view utility assessment scores of other properties, and additionally the utility assessment engine 110 can present a measure of central tendency (e.g., mean) of utility assessment scores (e.g., within the same geographic area).

The utility assessment system 100 can receive refinement information 122 from the user of the user device 120, which can modify the utility cost assessments 124. For instance, the user device 120 can identify a number of people that will live in the property, ages of the respective people, average temperatures the user is to keep the climate of the property during different seasons, e.g., summer and winter, and whether the user intends to generally occupy the property during the day. In some implementations, when determining initial utility cost assessments 124, the utility assessment engine 110 can utilize assumptions describing average characteristics of properties, e.g., average number of occupants in a property, and the refinement information 122 can identify accurate information for the user's property. In this way, the utility assessment engine 110 can update the utility cost assessments 124, and provide the updated utility cost assessments for presentation on the user device 120. The utility assessment engine 110 can store the refinement information 122 in one or more databases, e.g., the user information database 108, or in memory included in, or accessible to, the utility assessment system 100. The utility assessment system 100 can associate the refinement information 122 with information, e.g., anonymized information, such as identifiers of an area that includes the property, e.g., metropolitan region, city.

As described above, the utility assessment system 100 can maintain property profile information for properties, and can utilize included information to determine utility cost assessments 124, or to determine refinement information 122. Property profile information can include information associated with a property that can affect or inform utility usage or utility costs associated with the property. For instance, property profile information can include property improvement projects implemented by a prior, or present, property owner, such as upgrading windows, heating and cooling systems, a washing machine, purchasing ‘low-flow’ toilets, upgrading a sprinkler system in a backyard for more efficient use of water, and so on. The utility assessment system 100 can access the property profile information for the requested property, and utilize the property profile information when determining utility cost assessments 124, or the utility assessment system 100 can use the property profile information to determine refinement information 122 (e.g., upon a user request to update the utility cost assessments 124). As will be described, property owners can specify property improvement projects they have implemented, and/or the utility assessment system 100 can identify property improvement projects (e.g., from permits issued by a governmental entity, such as a permit for adding solar panels to a rooftop).

To determine an effect property improvement projects have on utility cost assessments 124, in some implementations the utility assessment system 100 can store information describing estimated utility usage reductions for one or more property improvement projects (e.g., average reduction in utility usage). Each of the property improvement projects can be associated with information specifying one or more reductions in usage of utility types (e.g., water, sewer, electricity), and the reductions can depend on particular characteristics of the property coupled with the extent to which the associated property improvement project was implemented. As described above, a property improvement project can be to install ‘low-flow’ toilets. The utility assessment system 100 can maintain information specifying a measure of central tendency (e.g., a mean) of the reduction in water utility usage for each installed ‘low-flow’ toilet. The system 100 can then determine utility cost assessments 124 based on a number of bathrooms included in a property absent information specifying a specific number of ‘low-flow’ toilets installed, or based on the actual number of ‘low-flow’ toilets installed if the property profile information includes the number. Similarly, for a property improvement project to install efficient sprinklers, the utility assessment system 100 can determine a reduction in water usage based on a square footage of a backyard of a property, and a mean reduction in water usage per square foot of backyard as specified by the property improvement project.

The property owner of the requested property can access associated property profile information, and can update the property profile to include information describing property improvement projects that were implemented, actual utility bills received over a period of time, and so on. In some implementations, the property owner can have a user account (e.g., a user name, password) associated with the utility assessment system 100, and can utilize the user account to access the property profile. In some implementations, the utility assessment system 100 (e.g., an administrator or other user associated with the system 100) can require that the property owner provide documents sufficient to prove, or indicate, ownership of the property. To enter a property improvement project that was implemented (e.g., for storage in an associated property profile), the proper owner can select (e.g., in a web page generated by the system 100) from among one or more selectable options (e.g., each option can be associated with a property improvement project for which the system 100 has associated utility reduction information). In some implementations, the property owner can provide model information of particular property systems (e.g., appliances) utilized in a property improvement project, and the utility assessment system can obtain information indicating reductions in utility usage (e.g., the information can indicate that a particular washing machine is 10% more efficient than an average washing machine).

The utility assessment system 100, or a presentation system in communication with the system 100, can further provide information associated with the property profile information for presentation on the user device 120. Property profile information can include associated time information, such that the utility assessment system 100 can present information according to an order in which it occurred. Additionally, the utility assessment system 100 can supplement the property profile information with information obtained from one or more other systems or databases, such as systems controlled by real-estate services or governmental organizations. For instance, the supplemental information can include dates of the property being purchased, dates associated with permits being issued by governmental organizations to modify the property (e.g., building permits, and so on). The utility assessment system 100, or a presentation system, can then generate user interface data (e.g., web pages) that specifies a timeline of events associated with the property. As described above, events can include specific property improvement projects that were implemented, sales of the property, permits associated with the property, and so on.

Additionally, in some implementations other users can have access to the property profile information, including appraisers, realtors, building inspectors, and so on. Each of these other users can supplement the property profile, for instance the appraisers and building inspectors can verify that property improvement projects were successfully implemented. Alternatively, the property owner can provide (e.g., upload) documentation from an appraiser or building inspector verifying the property improvement project. The verification information can be presented in one or more user interfaces, as described above, and optionally can be used when determining utility cost assessments 124 (e.g., verified property improvement projects can be trusted more, such that the full reduction in utility usage associated with the project can be utilized when determining the assessments 124).

In addition to refinement information 122, the user information database 108 can store information associated with received requests, e.g., utility cost estimates and utility assessment scores. In any situation where the utility assessment engine 110 receives, or obtains, private information, the utility assessment engine 110 is configured to provide privacy protections to users to anonymize, or disallow, the use of private information. Similarly, in some implementations the utility assessment engine 110 automatically anonymizes information.

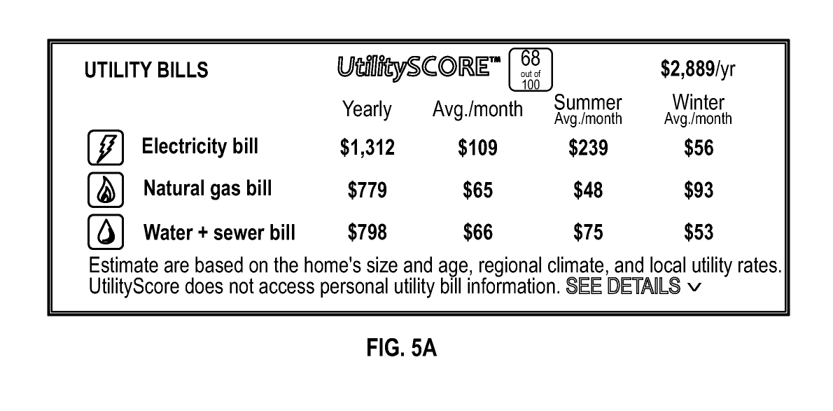

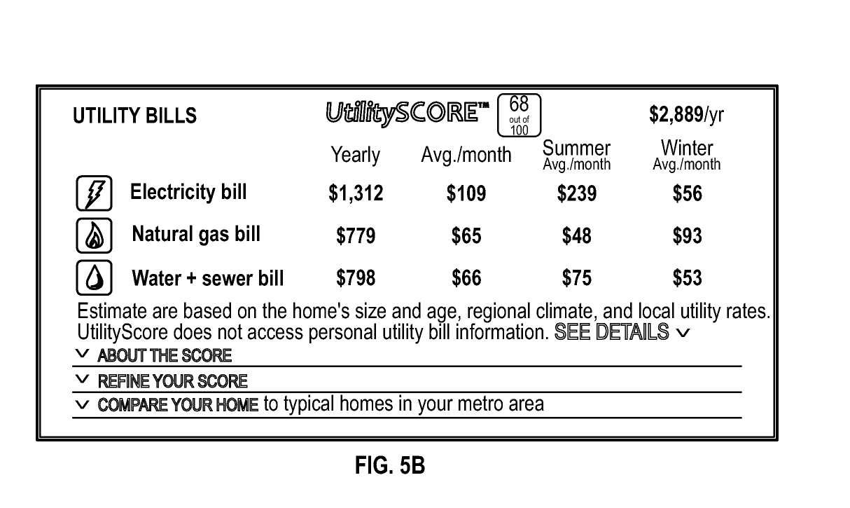

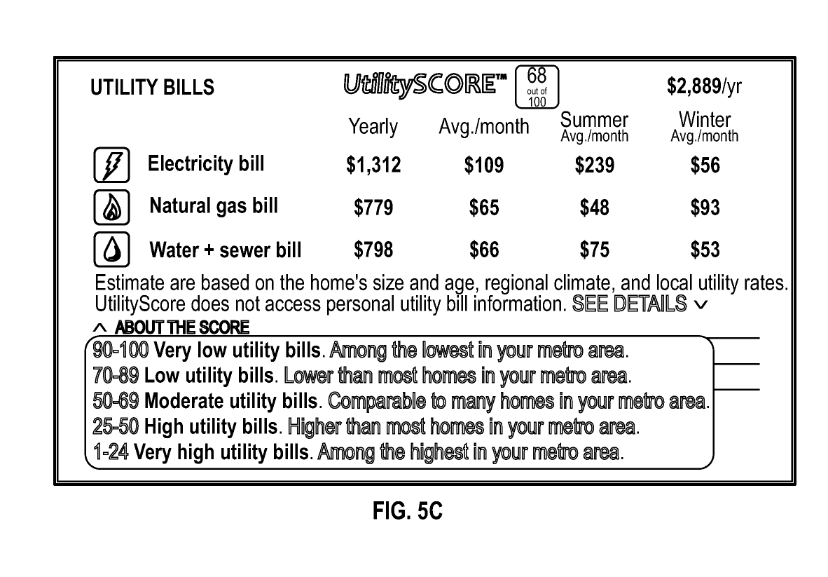

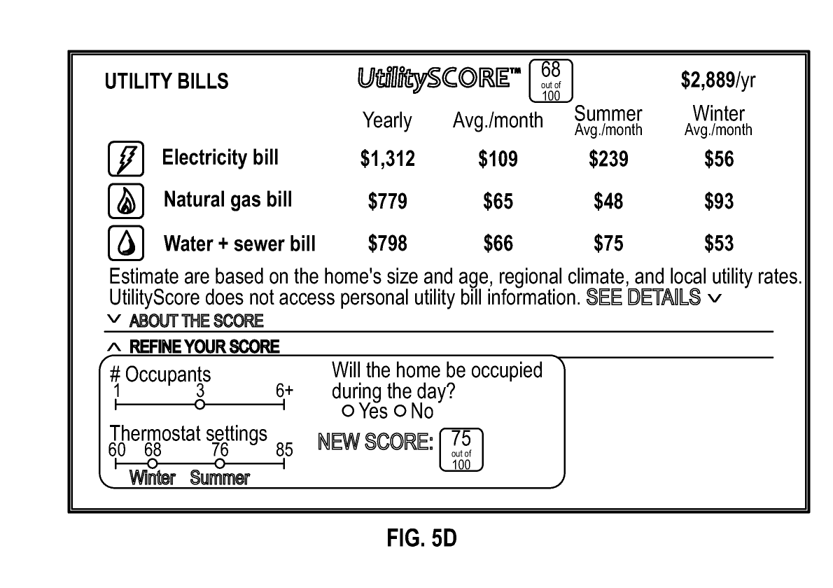

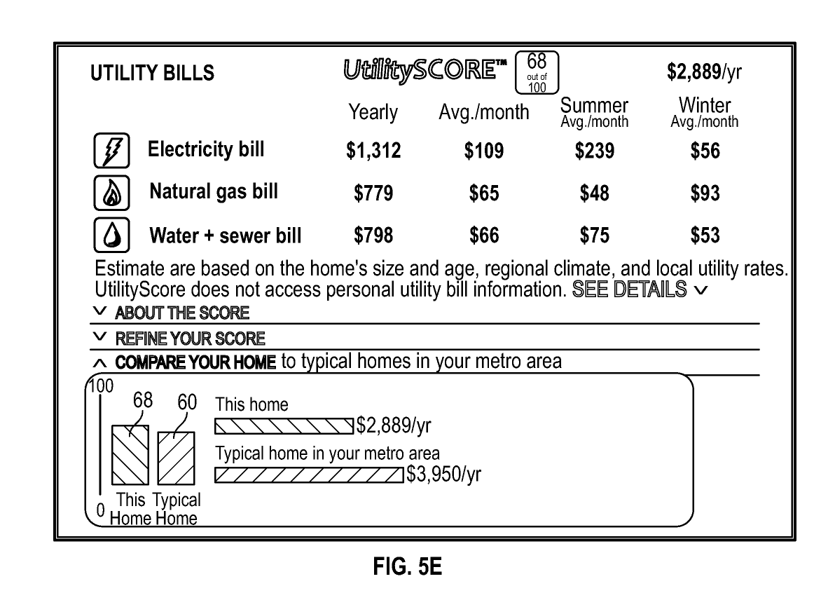

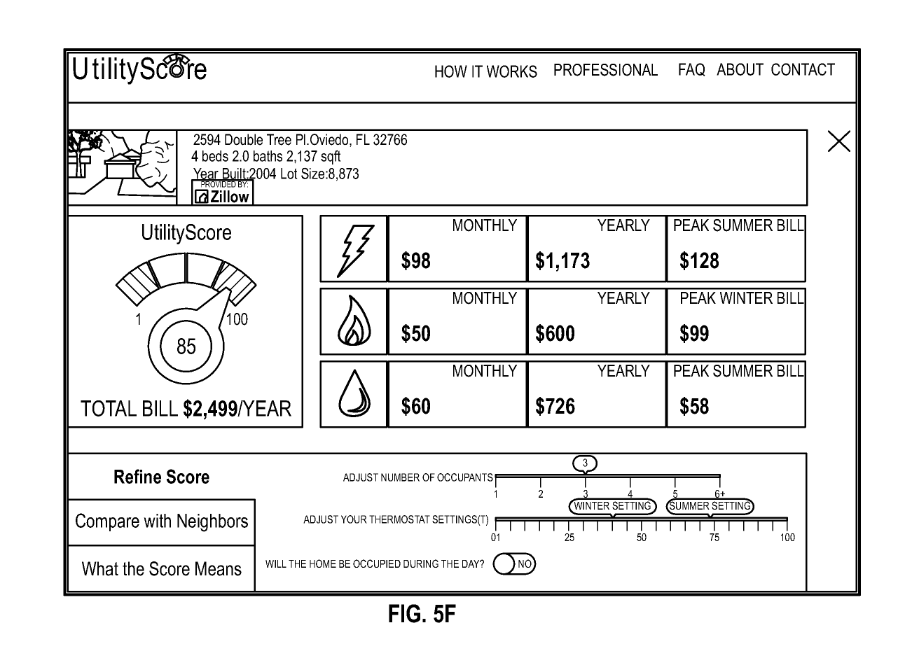

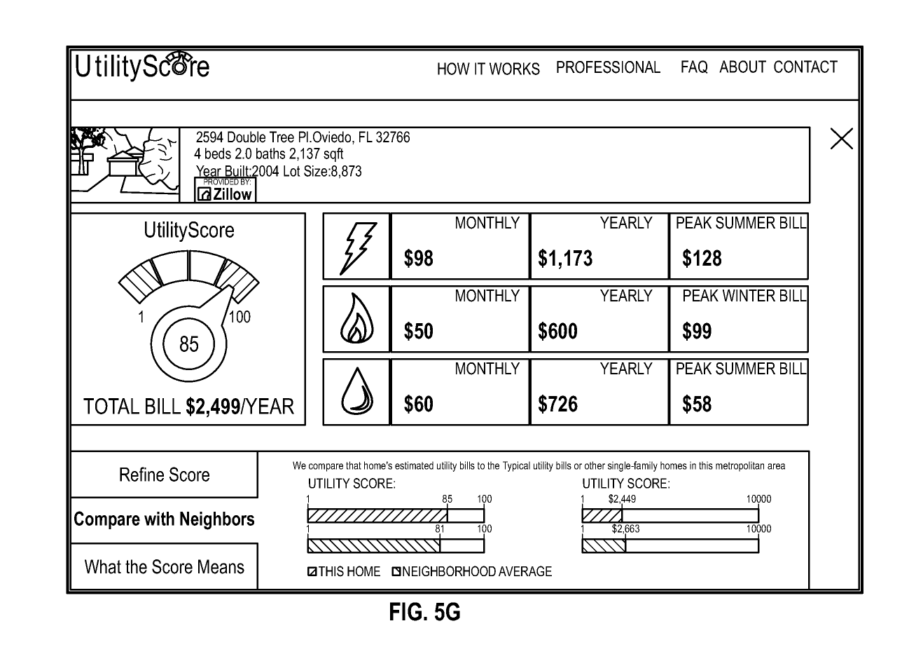

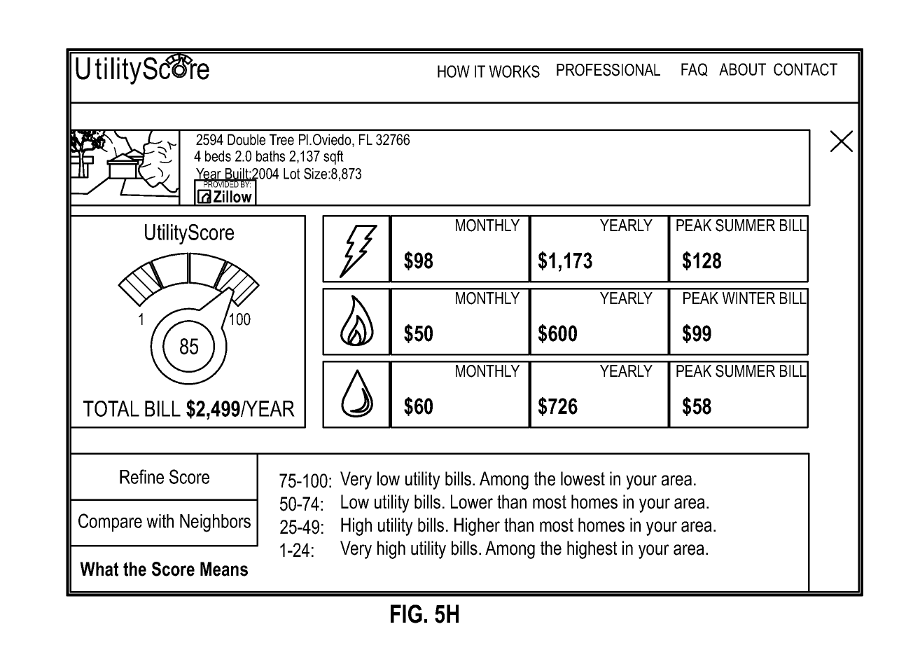

In some implementations, when providing the utility cost assessments 124 the utility assessment engine 110 can generate user interfaces that include the utility cost assessments. The user interfaces can be provided to a front end system, e.g., a system that provides a web page to the user device 110, and the front end system can include the user interface in the web page. That is, the utility assessment engine 110 can be integrated into a third party presentation system. The utility assessment system 100, and/or utility assessment engine 110, can be accessed by outside systems (e.g., controlled by third-parties) using one or more API calls. Examples of user interfaces are described below, in FIG. 5A-5E.

The above discussion has referenced databases, e.g., databases 102, 104, 106, and 108. It should be understood that each database can be partitioned into one or more databases, or one or more storage systems/subsystems, or combined into fewer databases. Additionally each database can be a part of another database, and the utility assessment system 100 can be in communication with a multitude of other databases that store information for temporary or more permanent storage. Similarly in the discussion below data and information can be stored in any of the databases, or in memory accessible to the utility assessment system 100.

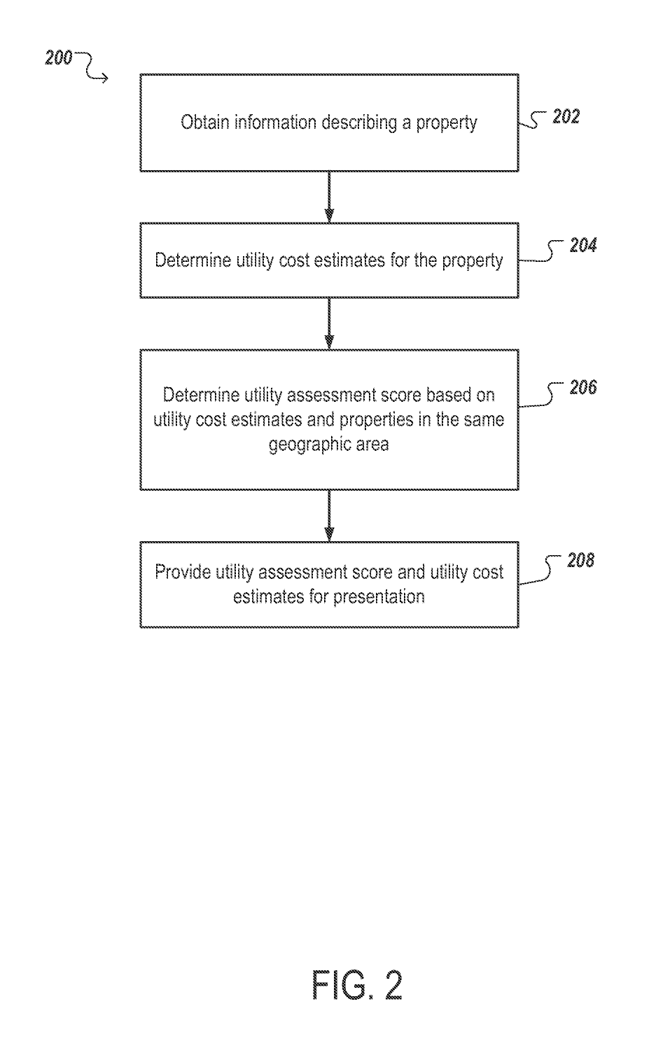

FIG. 2 is a flowchart of an example process 200 for utility cost assessment. For convenience, the process 200 will be described as being performed by a system of one or more computers, e.g., the utility assessment system 100.

The system obtains information describing a property (step 202). The system receives a request to provide utility cost assessments, e.g., utility cost estimates and a utility assessment score, on a particular property from a user device, or from an outside system in communication with the user device. Optionally, as described above, the system can receive requests from outside systems (e.g., using one or more API calls associated with the system). For instance, the requests can provide property information, and/or refinement information as will be described below, and the responses from the system can include utility estimates, utility scores, and so on.

In some implementations the request can specify a particular property, and the system can access a database, e.g., property information database 102, storing information describing characteristics of the property, e.g., year the property was built, square footage, number of rooms, number of bathrooms, square footage of a backyard, and so on. In some other implementations the system receives information describing characteristics of the property with the request.

The system determines utility cost estimates for the property (step 204). After obtaining information describing the property, the system determines utility cost estimates, e.g., electricity costs, natural gas costs, water costs, sewer costs, for an average year, for particular months and/or particular seasons, e.g., winter, summer.

To effect this determination, the system computes an estimated usage of each utility in a time period, e.g., a year. The system identifies an expected utility usage based off the obtained information describing the property. For instance, a property with more square footage will be expected to use more electricity, and a property with electric heating will be expected to use more electricity on heating costs than a property heated by natural gas or oil. Additionally, the system can utilize assumptions about propertys in this determination. For instance, the system can assume that there are a particular number of occupants in the property, e.g., 2, 3, 4, that the thermostat in the property will be set at a particular number, and whether the property will be occupied during the day.

The system then computes an estimated usage of each utility for particular months and/or seasons. Since utility usage will depend on climate information of seasons, e.g., natural gas usage can rise in the winter, the system obtains climate information for the area that includes the property, e.g., from the International Energy Conservation Code climate zones, and/or from information from the National Oceanic and Atmosphere Administration identifying Cooling Degree Days or Heating Degree days of each month for an area that includes the property. The system can utilize this information to determine, for example, that the winter months, e.g., months that include a larger quantity of Heating Degree Days, will be expected to use more natural gas on heating, e.g., if the property makes use of natural gas for heat. Additionally, the system can obtain weather prediction information to modify, or supplement, the obtained climate information. In some implementations, the system can determine spatial information of the property, including the property's orientation (e.g., with respect to one or more axes) and layout information. That is, the system can obtain (e.g., from a governmental or commercial database or system), information describing the property's location and orientation. In some implementations, the system can obtain imagery (e.g., satellite imagery, geo-rectified satellite imagery), and determine the property's layout and orientation. The system can modify the climate information based on the orientation and layout. As an example, a property with an east-west ridgeline, can maximize the length of the property, and using more windows on the southern side, can reduce the sun's heat on the property during summer (e.g., reducing air conditioning costs), while increasing the sun's heat on the property during winter. The system can obtain the orientation information, and if the system stores, or determines (e.g., from imagery of the property obtained through a ‘street-view’ search, satellite imagery), or receives (e.g., refinement information), information indicating installed property systems, such as types and locations of windows, the system can more accurately determine utility usages. Computing estimated usages of utilities is described below, with reference to FIG. 4.

After computing estimated usages of respective utilities, the system obtains utility rates for an area that includes the property, e.g., rates set by public, private, or municipal utility providers, that provide the utilities to the area. Since utility rates can fluctuate depending on season and month, the system obtains specific utility rates for each month and/or season. Similarly, the system can receive information identifying particular utility companies for the area that includes the property. That is, particular areas can include multiple utility companies that provide the same utility, and the system can receive (e.g., from the user device) selections of particular utility companies. In this way, the system can determine, with a great specificity, utility assessments for the property.

The system then determines utility cost estimates based on the utility rates and estimated usages of respective utilities. That is, the system applies the utility rates for specific months and/or seasons to the determined estimate usages for respective months and/or seasons. From this, the system obtains utility cost estimates for an average year, a particular month and/or season.

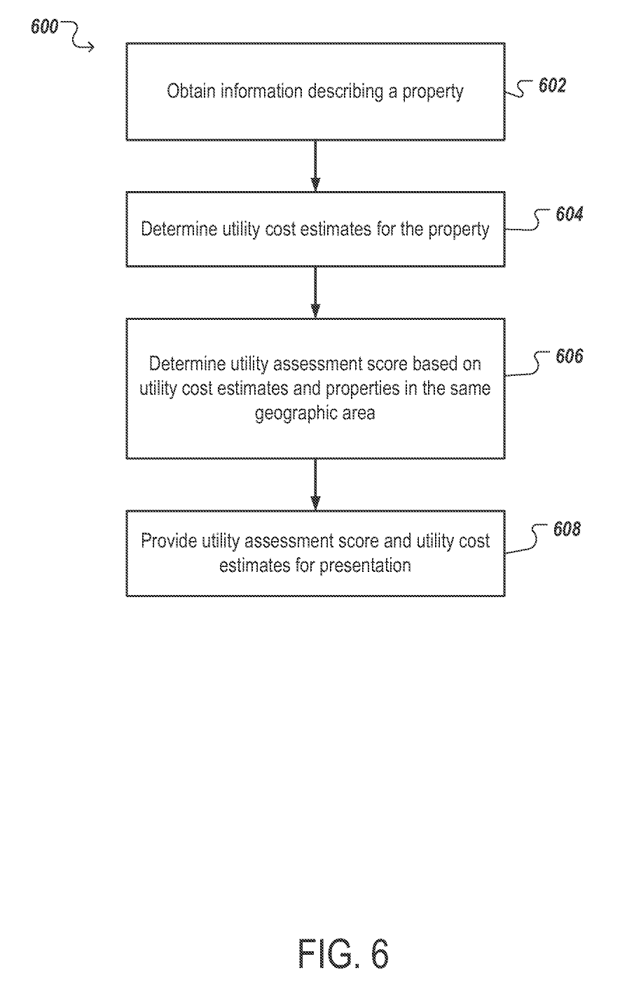

Furthermore, as will be described (e.g., in FIG. 6), the system can access property profile information for the requested property, and determine whether any property improvement projects have been implemented for the project. Since as will be described (e.g., in FIG. 4), the system determines estimates usage of each utility based on characteristics of the property, the system can utilize property profile information to determine utility usage and costs with greater accuracy.

The system determines a utility assessment score from the determined utility cost estimates (step 206). The utility assessment score is a score normalized with respect to other properties in the same area, e.g., postal code, city, metropolitan region, allowing a user to compare expected utility costs of different properties by examining their respective utility assessment scores. The utility assessment score can be a number from 1-100, with an average, or median, utility assessment score being a particular fixed number, e.g., 50, 60, 70, and can be based on an empirical distribution of typical utility bills among building in a city, metropolitan area, or country. A utility assessment score for a property that is greater than the average utility assessment score can represent, e.g., to a user, that utility costs for the property are likely to be less than an average property in the area. The system can store the utility assessment score in one or more databases, e.g., the user information database 108.

In some implementations, to determine the utility assessment score, the system determines a measure of central tendency of utility cost estimates of all properties in the area, e.g., the average property described above. The system then assigns an average utility assessment score as corresponding to the average utility cost estimates, and determines a distance from the average utility cost estimates to the determined utility cost estimates for the property. From this distance, the system can determine a utility assessment score for the property. The system can obtain utility costs estimates of all properties from one or more databases, e.g., the user information database 108.

In some implementations, the system determines the utility assessment score by comparing the determined utility cost estimates to average utility costs actually paid by property owners in the same area (e.g., postal code, city, metropolitan area, and so on). The system can obtain actual utility costs for all properties in the area and compute a measure of central tendency to identify amounts of money that property owners are actually providing to various utilities. The system then compares the determined utility cost estimates to these average amounts of money. The system can obtain the average utility costs from one or more databases, or from public information released by a governmental organization or utility company. For instance, the system can access information (e.g., anonymized information) associated with smart meters (e.g., Green Button information) to determine utility usage for an area and/or particular properties.

In some implementations, the system can obtain average characteristics of properties in the same area. For instance, the system can obtain an average amount of bedrooms, average square footage, and so on. From these average characteristics the system can determine utility cost estimates for the average characteristics, and assign the average utility assessment score as corresponding to the utility cost estimates of the average property. The system can then utilize the average utility assessment score, along with distances from the average characteristics the requested property is, and generate a utility score based on the distances.

The system provides the utility cost estimates and utility assessment score for presentation (step 208). The system generates user interface data that includes the utility cost estimates and utility assessment score for presentation on a user device. The system can also provide the user interface data to an outside system for presentation on the user device. Examples of user interfaces are described below, with reference to FIG. 5A-5E.

Additionally, the system can obtain a sales price of the property (e.g., from one or more commercial real estate databases or systems), and determine estimate mortgage costs, and other costs of owning/operating the property (e.g., insurance, closing costs, and so on). The system can then determine utility costs as a percentage of the total cost of ownership of the property, enabling the user to better understand how the utility assessment score correlates to cost of ownership. Optionally the system can access information describing properties in the same area (e.g., same neighborhood, within a threshold radius of the property), and determine properties with better (e.g., higher) utility assessment scores, such that the savings in utility costs associated with the properties will enable the user to spend more on purchase prices of the properties. For instance, the system can determine that a different property located within a threshold distance of the property identified in the request, will cost the user a similar (e.g., within a threshold amount) amount of money to own/operate, as the requested property. In some implementations, the user can indicate that the system is to identify other properties associated with costs of ownership within a user-selected amount.

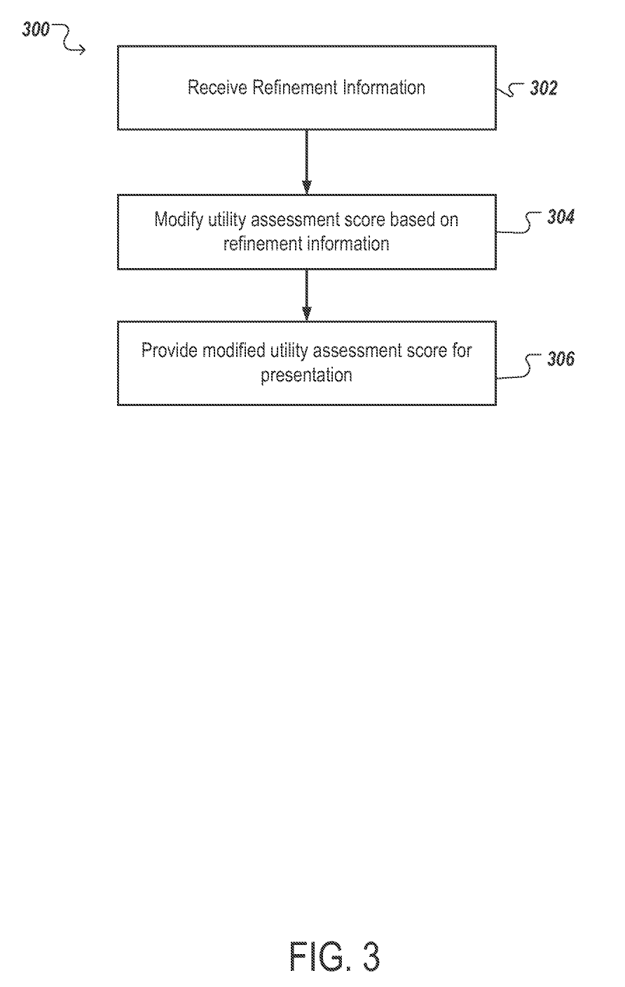

FIG. 3 is a flowchart of an example process 300 for user refinement of a utility cost assessment. For convenience, the process 300 will be described as being performed by a system of one or more computers, e.g., the utility assessment system 100.

After providing the utility cost estimates and utility assessment score for presentation, the system can receive refinements to information describing usage of the property, or characteristics of the property. In this way a user can provide information that more accurately describes the property, or her/his usage of the property. Refinement information can include any information that can affect the utility cost estimates and utility assessment score, such as information altering utility usage, utility rates, utility usage tiers, property size, and so on from default parameters.

The system receives refinement information (step 302). The user can access an interactive document (e.g. a web page) provided by the system, or an outside system, which can be rendered by a user device of the user, such that the user can interact with the document. The user can interact with the document to input refinement information, which for instance can include a number of occupants that will occupy the property, a thermostat setting for the property, e.g., a minimum and maximum temperature acceptable by the user, thermostat settings depending on seasons (e.g., summer, winter, fall), and whether the property will be occupied during the day. In some implementations the user can provide other refinement information, such as whether they plan on purchasing solar panels, a type of heating that the property has, and so on. An example user interface is described below, with reference to FIG. 5D.

Additionally, in some implementations the system can receive information identifying property systems (e.g., appliances, or other systems), to be included, or included, in the property. As an example, the system can access property profile information for the requested property, and obtain maintained information identifying property systems. The system can obtain or determine estimates of the expected utility usage of each property system. For example, the system can obtain (e.g., from commercial or governmental databases) information specifying utility usage associated with each property system, and/or information specifying increase in efficiency associated with the property system. As will be described in FIG. 4, when determining utility cost estimates the system utilizes formulas associated with values (e.g., constants, time-varying constants) that indicate average utility usage based on characteristics of a property. The system can modify the determined utility cost estimates (e.g., the values included in the formulas) based on the increases, or optionally decreases, in efficiency afforded by the property systems. That is, a particular formula associated with determining utility usage associated with electric space heaters can be modified (e.g., multiplied by a scaling factor) in accordance with increases, or decreases, in efficiency (e.g., with respect to an average efficiency of electric space heaters) of a particular electric space heater utilized in the property. In this way, a more efficient space heater utilized in a property can be taken into account, enabling better modeling of estimated utility usage.

In some implementations, a realtor, or property owner, can walk around the property and input names, or scan barcodes of, property systems in the property, e.g., into a mobile application executing on the user device in communication with the system. The mobile application can enable the user device to identify property systems based on associated bar codes (e.g., the mobile application can access, include, or make use of, a bar code or Quick Response Code reader). The realtor can have a user account associated with the system (e.g., the system can verify that the realtor is a properly licensed realtor), and the system can store the property system information in a property profile for the requested property. As the mobile application determines bar codes, or imagery as will be described, the mobile application can trigger the system to store property system information. Additionally, the mobile application can capture imagery (e.g., digital imagery) of name plates. The system can, or mobile application, can analyze the captured imagery to identify textual information or logo information included in the captured imagery. For instance, the system can utilize computer vision techniques to identify text (e.g., determining boundary information of objects and features indicated by particular color contrasts, and utilizing pattern matching on the bounded objects to identify characters). Additionally, for recognizing logos, the system can utilize computer vision techniques, including Scale invariant feature transforms, trained on logo information (e.g., unique, interesting, features associated with each logo), and can process the captured imagery to determine logos. Using both logo and textual information, the system can utilize information describing utility usage of property systems (e.g., the system can query an outside search system that maintains property system information). For instance, the system can determine that a particular logo corresponds to ‘Company A’ and that the textual information includes an identifier (e.g., a model number, a SKU number). The system can then search for property systems manufactured, or otherwise associated with, Company A, that are also associated with the identifier. Similarly, the realtor (or property owner, or other appropriate user), can capture imagery of other property systems included in the property to obtain visual information describing the property systems (e.g., features of the property systems), such as windows, vegetation (e.g., vegetation in a backyard or front yard), insulation, and so on. The system can determine features in the captured imagery indicative of types of property systems, enabling the system to identify a type of lawn, whether native plants are being used, whether double-paned windows are being utilized, and so on. In addition, the realtor, property owner, or other appropriate user, can input specific property systems being utilized in lieu of capturing imagery, and can utilize a mobile application as described above, or a computer system such as a laptop, desktop, tablet, and so on.

In some embodiments, the refinement information can be automatically retrieved from records, for example from user-recorded utility readings, parsed from a utility website, or downloaded using a utility record API. For example, a user can provide login information to a utility website, and the system can automatically retrieve (for example using a Green Button or other API) electricity usage measurements by the day, hour, or other interval. Thus, the system can automatically determine at least some refinement information based on historical usage patterns.

The system modifies the utility cost estimates and utility assessment score based on the refinement information (step 304). The system uses the refinement information to update the utility cost estimates. For instance, if the system utilized an assumption that three people were to occupy the property, and the refinement information identifies five, the system can increase the utility cost estimates. Similarly, the system can obtain thermostat settings that the user intends to utilize, and update the utility cost estimates for particular months and/or seasons. If the user prefers a warmer temperature than a temperature the system had utilized to initially determine utility cost estimates, the system can determine that utility cost estimates will be higher, e.g., in winter months, from the added cost of heating. Additionally, if the user indicates that he/she will be purchasing solar panels, the system can reduce the electricity cost estimates. Similarly, the system can update utility usage based on property systems, to be included, or presently included, in the property, e.g., the system uses utility usage associated with each property system, to update the utility costs estimates as described in FIG. 4 below. For instance, the system can determine that a backyard containing all native plants will utilize less water than a backyard containing grass (e.g., a threshold percentage less, such as 30%, 40%, 60%, and so on).

The system then updates the utility assessment score based on the updated utility cost estimates. The system can also refine utility cost estimates for other properties in the same area, based on the received refinements from all users. The system can then determine a new average utility assessment score, and update the utility assessment score based on the new average.

The system provides the modified utility cost estimates and utility assessment score for presentation (step 306).

The system provides a user interface that includes the updated utility cost estimates and utility assessment score for presentation on a user device. An example of a user interface is described below, with reference to FIG. 5D.

The description above included a user specifying refinement information when viewing information associated with a particular property, including utility cost estimates and an utility assessment score. In some implementations, other users, such as a property owner, a real-estate agent, a building inspector, and so on, can input refinement information for storage by the system (e.g., in a property profile associated with the particular property).

FIG. 4 is a flowchart of an example process 400 for determining utility cost estimates. For convenience, the process 400 will be described as being performed by a system of one or more computers, e.g., the utility assessment system 100.

The system determines electric utility cost estimates for a property (step 402). As described above in FIG. 2, the system receives an identification of a property and obtains information describing the property. The system determines estimates for a cost of using electricity in the property for one or more time periods, e.g., an average year cost, an average cost for particular months in the year, an average cost for particular seasons. Additionally, the below formulas can be modified according to property improvement projects associated with, or specific property systems included in, the property. As described above, with respect to FIG. 3, the system can obtain information identifying property systems utilized in the property, and can modify the below determined utility cost estimates according to actual utility usage of the property systems and/or efficiencies afforded by the property systems. Similarly, the system can modify the utility cost estimates according to property improvement projects that provide more efficient usage of utilities, which is described below in FIG. 6.

The system determines an expected quantity of electricity, e.g., measured in kWh/year, that the house will utilize in a year. The system computes a sum of expected electricity usage based on particular characteristics of the property.

For instance, the system can determine whether space heaters in the property are electric, e.g., based on property records, typical property conditions in that area based on data from the United States Census Bureau or a real estate partner, or user-provided data, and if so can compute an expected electricity usage for the space heaters. For example, the system computes:

$$\frac{kWh}{year} = ( A [ base usage ] + B * ( Square footage of property ) + C * ( number of occupants ) ) * D [ home age multiplier ]$$

The values A, B, C, and D vary by climate information, and can be determined through calibration with energy use databases such as the U.S. Department of Energy Residential Energy Consumption Survey, or determined by a machine learning model based on actual home energy use data. Determining the values is described more fully below.

The system can determine whether heating water in the property is done by electricity, e.g., based on property records, typical property conditions in that area based on data from the United States Census Bureau or a real estate partner, or user-provided data, and if so computes an expected electricity usage for space heaters. For example, the system computes:

$$\frac{kWh}{year} = E [ base usage ] + F * ( number of occupants )$$

The system can determine whether the property includes air conditioning, and if so computes an expected electricity usage. For example the system computes:

$$\frac{kWh}{year} = ( G [ base usage ] + H * ( Square footage of property ) + I * ( number of occupants ) ) * J [ home age multiplier ]$$

The system can determine whether the property includes a pool, e.g., an indoor or outdoor pool, and if so computes an expected electricity usage. Additionally the system determines whether the pool is heated by electricity. For example the system computes:

$$\frac{kWh}{year} = K [ base usage ] + L$$

The value of K can be an amount of electricity necessary to run the pool, e.g., lights, filters, and so on. The value of L identifies an amount of electricity the property is expected to use on heating the pool, and can vary depending on whether the pool is an indoor or outdoor pool.

The system can determine whether the property includes a spa, e.g., an indoor or outdoor spa, and if so computes an expected electricity usage. Additionally the system determines whether the spa is heated by electricity. For example the system computes:

$$\frac{kWh}{year} = M [ base usage ] + N$$

The value of M can be an amount of electricity necessary to run the spa, e.g., lights, filters, and so on. The value of N identifies an amount of electricity the property is expected to use on heating the spa, and can vary depending on whether the spa is an indoor or outdoor spa.

The system can determine a quantity of electricity that the property is expected to use on property systems, such as appliances, and plug loads. For instance the system computes:

$$\frac{kWh}{year} = O [ base usage ] + P * ( Square footage of property ) + Q * ( number of occupants )$$

The system can determine a quantity of electricity that the property is expected to use on lighting. For instance the system computes:

$$\frac{kWh}{year} = R [ base usage ] + S * ( Square footage of property ) + T * ( number of occupants )$$

As described in FIG. 2, the system can utilize assumptions about properties. For instance, the system can utilize an assumption that the property will include three occupants, at least until receiving refinement information described in FIG. 3. Additionally, if the system cannot determine particular characteristics of the property, e.g., whether the property includes a pool, the system can utilize expected characteristics for properties in the same area, e.g., if a majority of properties include a pool the system will assume a pool is present. The assumptions about properties can be stored in one or more databases, e.g., the user information database 108 and/or the property information database 102.

Additionally, the values described above, e.g., values A-T, can be determined by the system empirically. That is, the system can obtain actual electricity usage costs for properties in the area, and determine values that comport with the actual electricity usage. If the system cannot obtain actual electricity usage for each characteristic specifically, e.g., usage for a pool, the system can utilize machine learning techniques to identify a quantity of electricity for each characteristic. The system can then determine the values. As an example, the system can obtain smart meter data (e.g., Green Button data which has been anonymized) and utilize the smart meter data to determine values that best correlate characteristics of properties to the empirically determined smart meter data. Optionally, the system can utilize information specifying an age of the property to provide a multiplier to particular values. For instance, an older property might be expected to leak heat at a greater rate than a newer property, such that the system can modify one or more values associated with heating the property to increase by a percentage. However, in some geographic areas, older properties might be generally built from particular materials (e.g., thick brick homes), such that heat is leaked at a lesser rate than modern built homes, and the system can modify the values to be reduced by a percentage.

In some implementations the values A-N can vary by climate information, e.g., the values can be greater or smaller depending on the time of year, or region of the country. Thus, properties in different geographical regions can employ different values. The system can obtain climate information, and store the values, in one or more databases, e.g., the climate information database 106.

Furthermore, the values can vary over time, including as described above according to climate information (e.g., based on season data), but also can vary depending on time of day. For instance, utility rates can vary based on time of use (e.g., electricity costs can be higher in the evening in contrast to during the day, and so on). The system can utilize, for instance, refinement information to determine if a user is going to be at home during the day, and modify the values to depend on the time of day.

The system can additionally modify the above determined utility estimates, for instance, if the system has information identifying that the property includes solar panels, the system can subtract a value from the sum described above.

After determining an expected quantity of electricity for a year, the system determines expected quantities of electricity for each month in the year. That is, the system distributes the annual determined quantity depending on the month.

If the property includes electric space heating, the system can determine that the determined annual quantity of electricity for space heating can be distributed to each month in proportion to climate information for each month, e.g., in proportion to Heating Degree days for each month.

If the property includes electric water heating, the system can determine that the determined annual quantity of electricity for water heating can be distributed equally for each month.

If the property includes electric air conditioning, the system can determine that the determined annual quantity of electricity for air conditioning can be distributed in proportion to climate information for each month, e.g., in proportion to Cooling Degree Days for each month.

If the property includes a pool, the system can determine that the determined annual quantity of electricity for the pool and heating the pool can be distributed only to months that the pool is expected to be in operation. An outdoor pool in a climate zone that includes cold winter months can be expected to have less operational months than an outdoor pool in a continuously warmer climate. Similarly, if the pool is an indoor pool then, in some implementations, every month can be considered an operational month.

If the property includes a spa, the system can determine that the determined annual quantity of electricity for the spa and heating the spa can be distributed equally among the twelve months.

Similarly, the system can determine that the annual quantity of electricity for property system, such as appliances, plug loads, and lighting can be distributed equally among the twelve months.

The system then obtains information identifying electricity utility rates for an area that includes the property, e.g., utility rates by usage tier and month, season. The system computes expected electricity estimates from the utility rates and determined quantities of electricity.

The system computes electricity estimates for an average year, for average particular months, and/or for average seasons.

The system determines natural gas utility cost estimates for the property (step 404). The system determines an annual estimated quantity of natural gas, and then distributes the determined quantity based on month. To determine an annual estimated quantity, the system computes a sum of estimated quantities.

The system can determine whether the property includes space heaters that utilize natural gas, e.g., based on property records, typical property conditions in that area based on data from the United States Census Bureau or a real estate partner, or user-provided data, and if so computes an expected quantity of natural gas. For instance, the system computes:

$$\frac{therms}{year} = ( A [ base usage ] + B * ( square footage of property ) + C * ( number of occupants ) ) * D [ home age multiplier ]$$

The system can determine whether the property includes a water heater that utilizes natural gas, e.g., based on property records, typical property conditions in that area based on data from the United States Census Bureau or a real estate partner, or user-provided data, and if so computes an expected quantity of natural gas. For instance, the system computes:

$$\frac{therms}{year} = E [ base usage ] + F * ( number of occupants )$$

The system can determine whether the property includes a pool, and if so whether the pool is heated by natural gas. Upon a positive determination, the system computes an expected quantity of natural gas. For instance, the system computes:

$$\frac{therms}{year} = G$$

The value of G can vary depending on whether the pool is an indoor or outdoor pool, how many months per year the pool is in operation for that climate, and the magnitude of heating required per month for that climate.

The system can determine whether the property includes a spa, and if so whether the spa is heated by natural gas. Upon a positive determination, the system computes an expected quantity of natural gas. For instance, the system computes:

$$\frac{therms}{year} = H$$

The value of H can vary depending on whether the spa is an indoor or outdoor spa, how many months per year the spa is in operation for that climate, and the magnitude of heating required per month for that climate.

The system can compute an expected quantity of natural gas for property system, such as appliances, expected to be in the property. For instance, the system computes:

$$\frac{therms}{year} = I [ base usage ] + J * ( number of occupants )$$

As described above in step 402, these values can be determined empirically or with machine learning techniques. Additionally, the values A-F can vary by climate information. For instance, for a property located in a cold area, the quantity of natural gas used to heat a pool per month can be greater than a property located in a warm area.

After determining an expected quantity of natural gas for a year, the system determines expected quantities of natural gas for each month in the year. That is, the system distributes the annual determined quantity depending on the month.

If the property includes space heaters that utilize natural gas, the system can determine that the determined annual quantity of natural gas for space heating can be distributed to each month in proportion to climate information for each month, e.g., in proportion to Heating Degree days for each month.

If the property includes water heating that utilizes natural gas, the system can determine that the determined annual quantity of natural gas for water heating can be distributed equally for each month.

If the property includes a pool, the system can determine that the determined annual quantity of natural gas for heating the pool can be distributed only to months that the pool is expected to be in operation. An outdoor pool in a climate zone that includes cold winter months can be expected to have less operational months than an outdoor pool in a continuously warmer climate. Similarly, if the pool is an indoor pool then, in some implementations, every month can be considered an operational month.

If the property includes a spa, the system can determine that the determined annual quantity of natural gas for heating the spa can be distributed equally among the twelve months.

Similarly, the system can determine that the annual quantity of natural gas for property system, such as appliances, can be distributed equally among the twelve months.

The system then obtains information identifying natural gas utility rates for an area that includes the property, e.g., utility rates by usage tier and month, season. The system computes expected natural gas estimates from the utility rates and determined quantities of natural gas.

The system computes natural gas estimates for an average year, for average particular months, and/or for average seasons.

The system determines water utility cost estimates for the property (step 404). The system determines an annual estimated quantity of water, and then distributes the determined quantity based on month.

Water usage can be separated into an expected indoor quantity of water utilized, and an expected outdoor quantity of water utilized.

The system can determine an indoor quantity of water by determining whether the property was built before, or after, a threshold date, e.g., 1985, 1990, 1992, e.g., based on property records.

For properties built before 1992, the system computes:

$$\frac{CCF}{month} = A * ( number of occupants ) ,$$

where CCF represents one hundred cubic feet.

For properties built after, or during 1992, the system computes:

$$\frac{CCF}{month} = B * ( number of occupants )$$

The system then determines a quantity of outdoor water use. For instance, the system computes:

$$\frac{CCF}{month} = C * ( ln * ( lot area ) * D + E )$$

The value of C, is computed by the system, and can be a Theoretical Irrigation Requirement (TR), which can be computed from:

C=(Monthly Reference Evapotranspiration)−Lesser of [(0.25*Monthly reference Evapotranspiration) or (0.75*Monthly Effective Precipitation)]

If the monthly precipitation is less than 0.25 inches, then the monthly effective precipitation is zero. The value of C can, in some implementations, vary by climate.

The system can modify the above computation if it has information identifying a well or other stationary water source, e.g., reduce the estimated quantity of water.

After determining an expected quantity of water for a year, the system determines expected quantities of water for each month in the year. That is, the system distributes the annual determined quantity depending on the month.

The system distributes the expected indoor quantity of water for the year to each month equally.

Because the expected outdoor quantity of water varies by month, e.g., C varies by month; the system can determine the expected monthly outdoor water quantity usage.

The system then obtains information identifying water utility rates for an area that includes the property, e.g., utility rates by usage tier and month, season. The system computes expected water estimates from the utility rates, which can vary by usage type and/or usage tiers, and determined quantities of water.

The system computes water estimates for an average year, for average particular months, and/or for average seasons.

The system determines sewer utility cost estimates for the property (step 408).

The system obtains the value of the quantity of indoor water determined above in step 406, and assigns the value as the quantity of sewer volume. However, if the system obtains information identifying that the house includes a built in sewer, e.g., based on property records, or that sewer usage is not separately billed, then the system can assign the sewer utility estimates as an average cost of upkeep of a sewer, or make the cost zero.

The system then obtains information identifying sewer utility rates for an area that includes the property, e.g., utility rates by usage tier and month, season. The system computes expected sewer estimates from the utility rates and determined quantities of sewer volume.

The system computes sewer estimates for an average year, for average particular months, and/or for average seasons.

FIG. 5A is an illustration of an example user interface for utility cost assessment displaying an example utility assessment score.

The user interface can be provided to a user device after receiving an identification of a property, e.g., described above with reference to FIG. 2. The user interface displays various utilities, e.g., electricity, natural gas, water/sewer, with respective utility cost estimates for an average year, an average month, and summer and winter seasons. Additionally the user interface includes a utility assessment score, e.g., “68 out of 100.” The user interface includes a selectable option, e.g., “SEE DETAILS”, which a user can select to see an explanation of the utility assessments.

FIG. 5B is an illustration of an example expanded user interface for utility cost assessment. The illustration shows the user interface after the user has selected the “SEE DETAILS” selectable option. The user interface is updated to provide further selectable options, e.g., “ABOUT THE SCORE”, “REFINE YOUR SCORE”, “COMPARE YOUR HOME.”

FIG. 5C is an illustration of an example user interface for utility cost assessment displaying information about utility assessment scores. The illustration shows the user interface after the user has selected the “ABOUT THE SCORE” selectable option. The user interface is updated to describe the meanings behind various utility assessment scores, e.g., “50-69 Moderate utility bills. Comparable to many homes in your metro area.”

FIG. 5D is an illustration of an example user interface for utility cost assessment displaying refinement information. The illustration shows the user interface after the user has selected the “REFINE YOUR SCORE” selectable option. The user interface is updated to describe various refinements that the can make, e.g., “# of Occupants”, “Thermostat settings”, “Will the home be occupied during the day.” After receiving the selections of refinements, the utility assessment system 100 can update the utility cost estimates and utility assessment score, e.g., “75 out of 100.” Upon user interaction with the user interface to indicate refinement information, the system can be triggered to determine updated utility cost assessments, and present updated utility cost estimates and an updated utility assessment score. Refining the utility assessments is described above, with reference to FIG. 3. Optionally, the user interface can enable a user to enter property system information specific to the property, or the user can upload one or more captured images of property systems included in the property.

FIG. 5E is an illustration of an example user interface for utility cost assessment displaying utility assessment score comparisons. The illustration shows the user interface after the user has selected the “COMPARE YOUR HOME” selectable option. The user interface is updated to show an average utility assessment score, e.g., “60”, and respective utility cost estimates for the average utility assessment score, e.g., “$3,950/yr.” Similarly, the user interface displays the user's utility assessment score, e.g., “68”, and respective utility cost estimates, e.g., “$2,889/yr.”

FIG. 5F is an illustration of an example user interface for entering refinement information.

FIG. 5G is an illustration of an example user interface for utility score comparisons and utility estimates of a property, and properties within a threshold distance of the property (e.g., a same neighborhood).

FIG. 5H is an illustration of an example user interface for providing information describing a utility score.

In FIGS. 5A-5H, reference was made to specific qualitative descriptions, e.g., “SEE DETAILS.” It should be understood that these descriptions can be altered, and merely serve as examples of text.

FIG. 6 is an example flowchart 600 for maintaining and utilizing property profile information. For convenience, the process 600 will be described as being performed by a system of one or more computers (e.g., the utility assessment system 100).

The system maintains property profile information associated with properties (block 602). As described above, with respect to FIG, the system can store property profile information for multitudes of properties, with each property profile including information that can affect, or inform, utility usage and utility costs of the property. Each property profile can be associated with a property owner who can have an associated user account with the system enabling the property owner to include information in the profile. For instance, the property owner can specify actual utility costs of the property (e.g., the property owner can upload images, or documents, showing receipts, bills, and so on). Additionally, the system can access outside systems and databases (e.g., commercial real-estate databases, governmental databases) to determine permit information associated with the property. The system can determine, for instance, that a backyard of the property was upgraded from a sprinkler system to a drip irrigation system, or the system can determine, for instance, that a rain collection system was installed to supplement water being obtained from a water utility company. In some implementations, the system can access textual information associated with the granting of permits, and parse the textual information for particular keywords or phrases that indicate permits associated with reducing utility usage (e.g., “rain collection”, “solar panels”, and so on). The system can maintain the parsed textual information as being associated with the property profile.

Additionally, particular other users associated with the system can access property profiles to supplement the information provided by the property owner. In some implementations, the property owner does not have to be involved for a property profile to be created for the owner's property. For instance, a realtor, an appraiser, a building inspector, an insurance agent, and so on, can have user accounts associated with the system, and can create property profiles for properties they are involved with. As an example, a building inspector can verify that an improvement made to a property (e.g., a property improvement project as will be described) was implemented in accordance with governmental and safety regulations. The building inspector can access the system, cause the creation of a property profile for the property, and indicate implementation of the property improvement project. Furthermore, the other users can verify information input by the property owner, particularly improvements made to the property, specific property systems included in the property, and so on. As will be describe, information from the property profile can be presented to users interested in purchasing the property, providing accurate detailed insights into utility usage of the property.

The system receives a request for utility cost estimates for a property (block 604). As described above, with reference to FIG. 2, the system can receive requests for utility cost assessments of properties, and determine utility cost estimates, and utility assessment scores, for the requested properties. In some implementations, the system can utilize property profile information for the properties to modify the utility cost assessments.

As described above, with respect to FIG. 1, the system can determine utility usage reductions that are associated with property owners implementing property improvement projects. The system can access the property profile of a particular requested property, and when determining utility cost assessments, can utilize information describing utility usage reductions of any property improvement projects that have been implemented. In some implementations, the system can maintain information describing possible property improvement projects that can be made (e.g., templates of property improvement projects). When the property owner, or other user, updates a property profile, the property owner, or other user, can access one or more user interfaces (e.g., associated with web pages generated by the system) and select a closest property improvement project to that which was implemented. For instance, if the property owner installed a rain collection system, the property owner can select a property improvement project associated with a rain collection system.

Each property improvement project input into a property profile can optionally be associated with characteristics that can be designated by the property owner, or other user. For instance, the property owner can specify a size of the rain collection system, an amount and efficiency, or model number, of solar panels, number of gallons used in a washing machine, average flow rate of showerheads, electricity usage of efficient space heaters, air conditioning units, and so on. If the property owner, or other user, did not designate the characteristics, the system can utilize average characteristics. For instance, the system can determine that ‘low-flow’ toilets generally utilize a particular amount of water per flush (e.g., 1.6 gallons). The system can then utilize characteristics of the property to determine utility usage reductions, for instance the system can determine that a property that includes three bathrooms, likely now includes three ‘low-flow’ toilets. Similarly, the system can determine that for a property which includes a particular square footage, or rooftop square footage), likely includes a particular quantity, and/or area, of solar cells.

As described above, particular users, for instance non-property owners such as building inspectors, can access property profiles and verify that property improvement projects were properly implemented. These users can also verify the extent to which the property improvement was implemented (e.g., verify that all bathrooms now include ‘low-flow’ toilets, verify an extent to which solar cells were installed, verify a quantity of rainwater that can be captured).

The system determines utility cost estimates for the property (block 606). The system identifies property improvement projects associated with the property, which can include property improvement projects entered by the property owner, or property improvement projects determined from permit records, or real-estate information maintained by outside systems. The system determines the utility cost estimates according to the process 200, as described in FIG. 2, and modifies the utility estimates based on the implemented property improvement projects. For instance, as described above, the system can maintain utility reductions that are associated with one or more property improvement projects. The system can utilize characteristics of the property along with the utility reductions, to determine utility estimates for the property. Additionally, the system can obtain information identifying efficiency savings created by property improvement projects. For example, if the property owner included a rain collection system, the system can determine average rainfalls for the geographic area that includes the property (e.g., historical averages, upcoming averages due to weather prediction), and can use the rainfall information along with a size and efficiency of the rain collection system, to determine estimated water utility savings.

The system optionally provides access to the property profile associated with the property (block 608). As described above, the system can present the property profile information in one or more user interfaces (e.g., on a user device), such that the user of the user device can view a timeline of events associated with the property.

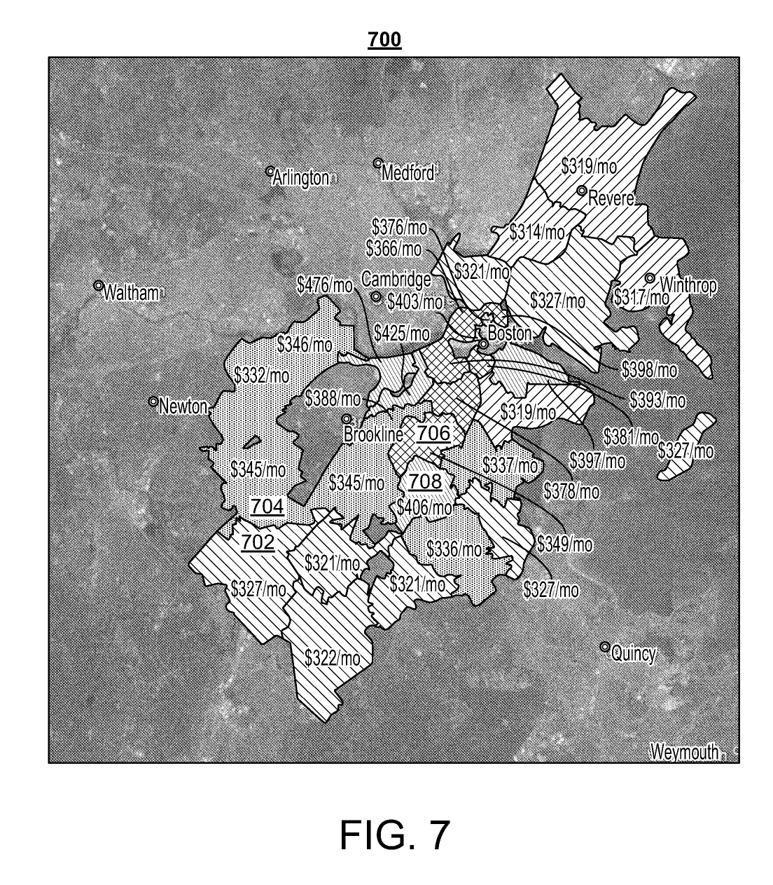

FIG. 7 is an example user interface 700 illustrating visual output associated with utility assessments generated for a geographic area. The system (e.g., the utility assessment system 100) can generate data visualizations of utility cost estimates, utility assessment scores, and so on, for presentation on a user device (e.g., the system can generate web pages to be rendered on the user device). For instance, the user can specify a particular geographic area, such as a zip code, census tract, a postal code, a neighborhood, a city, or an arbitrary geographic area (e.g., the user can pinch to zoom on a presented map), and the system can determine utility assessment information associated with properties in the geographic area.

As illustrated in FIG. 7, the user has requested information about a particular geographic area, and the system has determined utility cost estimates for properties included in the geographic area. For instance, the system has determined measures of central tendency (e.g., means, median) of utility cost estimates for properties included in the geographic area. In some implementations, the system can group sub-geographic areas in the requested geographic area, such that a threshold percentage of properties in clouded in the sub-geographic area have utility cost estimates within a threshold variance of each other. In some implementations, the sub-geographic areas can correspond to zip code, postal code, counties, cities, neighborhoods, and so on. The user interface 700 includes information identifying utility cost estimates of each sub-geographic area, and optionally each sub-geographic area can be color coded (e.g., the colors can be green, yellow, orange, red, in increasing order of utility cost estimates), or the sub-geographic areas can be shaded, or otherwise easily identified as corresponding to particular utility cost estimates, or ranges of utility cost estimates. For instance, a particular area 702 can be color coded green, or patterned or shaded in a particular manner, and be associated with a utility cost estimates of $327/month, Another area 704 can be color coded yellow, or shaded or patterned in a different manner, and be associated with utility cost estimates of $345/month. Another area 706 can be can be colored orange, or shaded or patterned in a different manner, and be associated with utility cost estimates of $349/month. Another area 708 can be colored red, or shaded or patterned in a different manner, and be associated with utility cost estimates of $406/month. Non-exhaustive list of patterns can include, cross-hatched, lines, bubbles, circles, triangles, figures, logos, and so on.

Optionally, upon user interaction with a sub-geographic region, the region can be expanded (e.g., zoomed in), and the system can determine utility cost estimates of smaller regions (e.g., neighborhoods, particular properties), within the sub-geographic region. In this way, complex information can be summarized to a user, and the user can interact with a zoom control to obtain more detailed information. Other visualizations can be implemented, including data visualization via different media, info graphics, video, photos, graphs, and so on, to showcase utility usage, home comparisons, trends, etc.

### Alternate Embodiments

As described above, the system (e.g., the utility assessment system 100) can be in communication with a user device of a property owner, a realtor, an inspector, and so on. In some implementations, the user device can execute an application (e.g., a mobile “app” downloaded from an application store) that is in communication with the system. A user of a user device can travel to a property being sold, and utilize the application to determine utility assessment information of the property. In some implementations, the system can actively monitor a location of the user device, and trigger the application executing on the user device if the user device is located at a property with a utility assessment score greater than a threshold, or is located at a property with utility cost estimates less than a threshold percentage of other properties located in a same geographic area. Additionally, the application can automatically obtain a utility assessment score at a location of the user, and present it to the user upon the user opening the application. Although actions herein are discussed as being performed by an application running on a user device, such actions can also be partially, entirely, or substantially performed server-side and user output pushed to the user device.

Furthermore, a user of the system can specify that he/she is looking for properties in a particular geographic area with utility assessment scores greater, or less than, one or more thresholds. The system can determine utility assessment scores, and provide information to the user indicating matching properties. Additionally, the system can monitor properties (e.g., monitor property profile information), and determine when properties match the criteria (e.g., a property's utility assessment score can increase after the property owner implements a property improvement project). The system can then trigger a notification to the user (e.g., email, phone, text), or the system can activate a mobile application executing on the user's user device to provide the information. In various embodiments, such notification can be instantaneous, real-time, or timely with respect to changes in criteria matching over time.

Additionally, as described above, the system can determine correlations between utility assessment scores (e.g., utility scores) and sales prices of properties. For instance, the system can obtain information monitoring sales prices of properties within a threshold period of time (e.g., from a real-estate database, system, and so on), and using on eor more machine learning algorithms, can determine information describing an effect that a utility assessment score has on a property. That is, the system can utilizing information describing with properties that share, or have similar, features (e.g., square footage, number of bedrooms, bathrooms, a neighborhood, zip code), and can determine an effect that utility scores of each property had on their sales price.

Each of the processes, methods, and algorithms described in the preceding sections may be embodied in, and fully or partially automated by, code modules executed by one or more computer systems or computer processors comprising computer hardware. The code modules (or “engines”) may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

In general, the terms “engine” and “module”, as used herein, refer to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, PHP, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the risk assessment system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer-implemented method comprising:
by a system of one or more computers,
receiving user input on a content item provided for presentation on a user device of a user, the content item being associated with presenting utility estimates for properties, the user input specifying a particular property;
accessing one or more databases and obtaining information describing the particular property, the information including characteristics of the property that affect utility usage associated with the particular property;
determining, using the characteristics of the property, utility estimates for the property, and combining the utility estimates to generate a utility score representing an overall utility efficiency with respect to disparate properties in a threshold distance of the particular property;
receiving, from the user device, refinement information associated with the particular property, the refinement information provided by a mobile device being positioned proximate to property systems included in the particular property and including imagery captured by the mobile device showing the property systems;
analyzing the captured imagery and obtaining visual information describing each property system captured in the imagery;
determining, using the information describing the property systems, utility information associated with the property systems, and modifying the utility estimates for the particular property based on the utility information associated with the property systems; and
providing, for presentation in the content item, an updated utility score determined from the modified utility estimates.

2. The method of claim 1, wherein determining utility estimates for the particular property comprises:
obtaining climate information for a geographic area that includes the particular property;
determining, using the obtained climate information, estimated utility usage for one or more utilities based on the characteristics of the particular property;
obtaining information identifying utility rates associated with the one or more utilities for the geographic area; and
determining, for each of the one or more utilities, a utility estimate using the utility rates and estimated utility usage.

3. The method of claim 2, wherein the one or more utilities include an electric utility and/or a water utility, and wherein determining estimated utility usages for the electricity utility and/or water utility comprises:
determining, based on characteristics of particular property including square footage and number of occupants, estimated utility usages of one or more of space heaters, water heaters, air conditioners, lighting, or other property systems.

4. The method of claim 1, further comprising:
obtaining information identifying properties with characteristics similar to one or more characteristics of the particular property, and wherein the identified properties are located with the threshold distance of the particular property;
determining respective utility scores for the identified properties; and
providing, for presentation, information describing the utility scores and identified properties, including information comparing the utility score of the particular property with the utility scores of the identified properties.

5. The method of claim 1, determining utility information associated with the property systems comprises accessing information, for each property system identifying increases or decreases in utility efficiency of the property system with respect to an average efficiency of a property system of a same type, and wherein modifying the utility estimates is based on the utility efficiencies of the property systems.

6. A computer-implemented method comprising:
by a system of one or more computers,
receiving, from a user, a request associated with a particular property for utility estimates of the particular property;
accessing one or more databases and obtaining information describing the particular property, the information including characteristics of the property that affect utility usage associated with the particular property;
determining, using the characteristics of the property, utility estimates for the property, and combining the utility estimates to generate a utility score representing an overall utility efficiency with respect to disparate properties in a threshold distance of the particular property; and
providing, for presentation, user interface data associated with the determined utility estimates and utility score, wherein the user interface data comprises selectable options for the user to specify refinements to characteristics of the property, and wherein selection of refinement information triggers the system to update the utility estimates and utility score.

7. The method of claim 6, wherein determining utility estimates for the particular property comprises:
obtaining climate information for a geographic area that includes the particular property;
determining, using the obtained climate information, estimated utility usage for one or more utilities based on the characteristics of the particular property;
obtaining information identifying utility rates associated with the one or more utilities for the geographic area; and
determining, for each of the one or more utilities, a utility estimate using the utility rates and estimated utility usage.

8. The method of claim 6, wherein combining the utility estimates to generate a utility score comprises:
determining measures of central tendency of utility estimates for a plurality of properties within the threshold distance of the particular property, and assigning an average utility score based on the measures of central tendency;
determining distances the determined utility estimates of the particular property are from the measures of central tendency; and
generating, using the average utility score, the utility score for the particular property based on the determined distances.

9. The method of claim 6 wherein combining the utility estimates to generate a utility score comprises:
obtaining information identifying measures of central tendency of characteristics of properties within the threshold distance of the particular property, wherein the characteristics include one or more of a number of bedrooms, square footage, backyard square footage, or number of bathrooms;
determining utility estimates based on the measures of central tendency of the characteristics, and assigning an average utility score based on the utility estimates; and
generating, using the average utility score, the utility score for the particular property based on differences between the characteristics of the particular property and the measures of central tendency of the characteristics

10. The method of claim 6, wherein refinement information includes average temperatures a thermostat associated with the particular property is to be set at, number of occupants that will be in the property, information identifying whether the particular property is to be occupied during the day.

11. The method of claim 6, further comprising:
accessing property profile information associated with the particular property, the property profile information specifying a particular property improvement project that has been implemented, wherein the property profile information includes information that affects, or informs, utility usage of the particular property; and
obtaining information specifying reductions in utility usage associated with implementing the particular property improvement project,
wherein determining utility estimates for the particular property is based, at least in part, on the specified reductions.

12. A non-transitory computer storage medium storing instructions that when executed by a system of one or more computers, causes the system to perform operations comprising:
receiving, from a user, a request associated with a particular property for utility estimates of the particular property;
accessing one or more databases and obtaining information describing the particular property, the information including characteristics of the property that affect utility usage associated with the particular property;
determining, using the characteristics of the property, utility estimates for the property, and combining the utility estimates to generate a utility score representing an overall utility efficiency with respect to disparate properties in a threshold distance of the particular property; and
providing, for presentation, user interface data associated with the determined utility estimates and utility score, wherein the user interface data comprises selectable options for the user to specify refinements to characteristics of the property, and wherein selection of refinement information triggers the system to update the utility estimates and utility score.

13. The non-transitory computer storage medium of claim 12, wherein determining utility estimates for the particular property comprises:
obtaining climate information for a geographic area that includes the particular property;
determining, using the obtained climate information, estimated utility usage for one or more utilities based on the characteristics of the particular property;
obtaining information identifying utility rates associated with the one or more utilities for the geographic area; and
determining, for each of the one or more utilities, a utility estimate using the utility rates and estimated utility usage.

14. The non-transitory computer storage medium of claim 12, wherein combining the utility estimates to generate a utility score comprises:
determining measures of central tendency of utility estimates for a plurality of properties within the threshold distance of the particular property, and assigning an average utility score based on the measures of central tendency;
determining distances the determined utility estimates of the particular property are from the measures of central tendency; and
generating, using the average utility score, the utility score for the particular property based on the determined distances.

15. The non-transitory computer storage medium of claim 12, wherein refinement information includes average temperatures a thermostat associated with the particular property is to be set at, number of occupants that will be in the property, information identifying whether the particular property is to be occupied during the day.

16. The non-transitory computer storage medium of claim 12, wherein the operations further comprise:
accessing property profile information associated with the particular property, the property profile information specifying a particular property improvement project that has been implemented, wherein the property profile information includes information that affects, or informs, utility usage of the particular property; and
obtaining information specifying reductions in utility usage associated with implementing the particular property improvement project,
wherein determining utility estimates for the particular property is based, at least in part, on the specified reductions.

17. A system comprising one or more computer systems and one or more computer storage media storing instructions that when executed by the one or more computers, cause the one or more computers to perform operations comprising:
receiving, from a user, a request associated with a particular property for utility estimates of the particular property;
accessing one or more databases and obtaining information describing the particular property, the information including characteristics of the property that affect utility usage associated with the particular property;
determining, using the characteristics of the property, utility estimates for the property, and combining the utility estimates to generate a utility score representing an overall utility efficiency with respect to disparate properties in a threshold distance of the particular property; and
providing, for presentation, user interface data associated with the determined utility estimates and utility score, wherein the user interface data comprises selectable options for the user to specify refinements to characteristics of the property, and wherein selection of refinement information triggers the system to update the utility estimates and utility score.

18. The system of claim 17, wherein determining utility estimates for the particular property comprises:
obtaining climate information for a geographic area that includes the particular property;
determining, using the obtained climate information, estimated utility usage for one or more utilities based on the characteristics of the particular property;
obtaining information identifying utility rates associated with the one or more utilities for the geographic area; and
determining, for each of the one or more utilities, a utility estimate using the utility rates and estimated utility usage.

19. The system of claim 17, wherein refinement information includes average temperatures a thermostat associated with the particular property is to be set at, number of occupants that will be in the property, information identifying whether the particular property is to be occupied during the day.

20. The system of claim 17, wherein the operations further comprise:
accessing property profile information associated with the particular property, the property profile information specifying a particular property improvement project that has been implemented, wherein the property profile information includes information that affects, or informs, utility usage of the particular property; and
obtaining information specifying reductions in utility usage associated with implementing the particular property improvement project,
wherein determining utility estimates for the particular property is based, at least in part, on the specified reductions.
